(19) United States
(12) Patent Application Publication
(10) Pub. No.: US 2005/0081052 A1
(43) Pub. Date: Apr. 14, 2005

(54) Global identity protector

(76) Inventor: Keith Anthony Washington, Oakland, CA (US)

Correspondence Address: Keith Anthony Washington, 2101 10th Ave, Oakland, CA, 94606, US

(21) Appl. No.: 10/683,069

(22) Filed: Oct. 10, 2003

(51) Int. Cl. G06F 12/14; G06F 11/30

(52) U.S. Cl. 713/200

(57) ABSTRACT

An identity theft protection system, which uses several security features to stop identity theft. The system combines a person's social security number and mailing address, to stop the issuing of identity theft credit cards. The person's address is used as a active security code on the system. The system uses a person's full description, and signature, to stop all identity theft fraud committed in person.

### BACKGROUND OF THE INVENTION

This invention relates to the prevention of identity theft, a system which verifies a person's identity.

Description

Every year the Federal Trade Commission releases its top 10 fraud complaints of the year. Ever since the year 2000, identity theft has topped the list. This year, the fraud of 380,000 people was reported to the FTC. As in 2000 and 2001 identity theft topped the list, accounting for 43 percent of the complaints lodged in the FTC's consumer sentinel database. The number of fraud complaints jumped from 220,000 in 2001 to 380,000 in 2002, and the dollar loss consumers attributed to the fraud they reported grew from $160 million in 2001 to 343 million in 2002. Making identity theft the fastest growing crime in america.

### OBJECTS AND ADVANTAGES

Accordingly, several objects and advantages of the present invention are:
(a) to provide a system which can stop the issuing of identity theft credit cards.

(b) to provide a system which can prevent a person from purchasing a automobile with another person's social security number.
(c) to provide a system which can stop a person from purchasing real estate, with another person's social security number.
(d) to provide a system which can stop a person from opening a bank account with another person's social security number.
(e) to provide a system which can stop a person from calling a bank and changing another person's mailing address to commit fraud.
(f) to provide a system which can stop a person from doing anything illegal with another person's social security number.

### BRIEF SUMMARY OF THE INVENTION

Accordingly, the reader will see that Global Identity Protector can be used to stop identity theft easily and conveniently, the system contains all of the necessary features to stop identity theft on all levels. Stopping the possibility of identity theft credit cards, and purchasing all big ticket items.

### DETAILED DESCRIPTION OF THE INVENTION

Any person who wants protection can simply download an identity theft protection system form, fill it out in long hand, have it notarized, and return it for filing. The system form is then loaded into a computer database, Global Identity Protector, this system is set up to give banks and every other lending institution, a rock solid tool to work with to prevent identity theft. All banks and other credit granters will log on, and enter an access code. A page will appear, that they will enter the person's name and social security number. The identity theft protection page on that person will now appear for reviewing. The system contains several security features, the system contains a person's full name in case the identity thief only knows the person's first and last name. The system contains a full description and photo, the photo is optional, this is for all credit applications that are filled out in person. If the description on the system does not match the person applying for credit, no credit will be granted. The system will use two security codes, one of which will not appear on the system itself when a bank or any other institution is reviewing the system, one of the codes will be entered into a box marked security code.

The computer will tell the institution if the code is correct or incorrect. This feature is on the system for credit cards that are ordered over the phone, on-line, or in the mail. The true purpose for this code is to block a family member or a spouse, who can obtain all of the necessary information to commit fraud. The system will also contain a person's mother's maiden name or code name, to give the institution another security feature to verify. The system contains a person's current, full mailing address. The person's social security number, and mailing address will be combined. Such as, 777-77-7777+2101-10-E-94606 the E stands for apartment E. This feature alone will stop the perpetrator from receiving credit cards or checks in the mail.

The address on the system is the only address banks can send credit cards and checks to. The actual digits of the person's address will follow their social security number, for matching and verifying the transaction. If a person moves, and wants to receive credit cards or checks at their new address, they must submit a new system form. The system will also contain the person's penmanship. All personal information on the system is handwritten, not typed. If the penmanship or signature doesn't match, credit will not be granted.

The system contains the signature of a notary, certifying that all of the information submitted is true. The system will also contain a person's right thumbprint. Preventing any employees from removing one system and replacing it for another with false information.

Operation

The manner of using Global Identity Protector is very simple and informative. If a perpetrator acquires a person's complete banking information such as, account number, mailing address and social security number. With the intent to call a bank to have checks sent to a false address.

After the bank talks to the perpetrator about sending the checks. They will simply enter the person's name and social security number into the database to verify that person's current address. The bank will see that the identity protection system, still has the person's real address as their current address. The bank will then tell the perpetrator that he or she must submit a new protection system form, if they want checks or credit cards sent to a new address. The person's social security number and current mailing address are combined turning the person's address into a security code and lock, that only they can change. Global Identity Protector blocks any fraudulent activity, dealing with anything that is mailed. When any institution mails credit cards or checks, they must print on the envelop, Postmaster Do Not Forward.

If the perpetrator goes on-line to order credit cards, after the application has been received by the bank or store, all they will need to do is enter the person's name and social security number into the system. They will see that the address on the application is not the same as the one on the protection system. If the perpetrator tries to order credit cards by phone the bank can ask the person for their security code, and their mother's maden name or code name. If the perpetrator was a family member or a spouse, and they live at the address of the person's identity that they are trying to steal, the security code will block the transaction. The security code will be known by only the person who ownes it.

If the perpetrator goes to a auto dealership to buy an automobile, after he or she fills out the credit application, the dealership will enter the person's name and social security number into the system. They will see a physical description the person's handwriting sample, and signature. If these things do not match, they can call the police and have the perpetrator arrested on the spot.

This system will also work on cyber identity theft, also known as account hijacking, for instance, eBay.com uses a fictitious user name for sellers and buyers. They also use a rating system which gives people points for every transaction. Therefore, people are useing every trick in the book to steal a person's password, so they can take over the person's user name and good rating; with the intent of posting goods for sale that do not exist. A person will bid on the item, when the auction ends, the perpetrator will tell the person where to send payment for the item.

Global Identity Protector can stop this activity by combining the person's user name with their address; such as Reddog+2101.E when the buyer sees, 2101.E, they will know that the address that they will send money to will start with 2101. The E stands for apartment E. If the perpetrator gives an address that starts with a defferent address, the buyer will know it is fraud, and will not send payment. If a person wants to change their address they will go to the web-site and enter the new address, and then they will call a 800 number that is posted on the web-site they will then be connected with an automated service; but they must call from the phone that is registered with the web-site. The service will verify the phone number and confirm, and activate, the new address, by informing the person to reenter the digits with a touch tone phone.

1. I claim: An identity theft protection system, which uses a person's social secruity number, and the actual digits of a person's address together, systematically, using the digits of the address as a security code and lock, for the process of matching and verifying all digits in the database, a system which is used to stop the issuing of identity theft credit cards.

2. I claim: An identity theft protection system which uses the actual digits of a person's address, as a active code, an account identifier, a security code and lock, a system and process which is used to prevent cyber identity theft, and account hijacking.
